(19) United States
(12) Patent Application Publication
(10) Pub. No.: US 2023/0362095 A1
(43) Pub. Date: Nov. 9, 2023

(54) METHOD FOR INTELLIGENT TRAFFIC SCHEDULING BASED ON DEEP REINFORCEMENT LEARNING

(71) Applicant: Zhengzhou University of Light Industry, Zhengzhou (CN)

(72) Inventors: Erlin TIAN, Zhengzhou (CN); Wanwei HUANG, Zhengzhou (CN); Qiuwen ZHANG, Zhengzhou (CN); Jing CHENG, Zhengzhou (CN); Xiao ZHANG, Zhengzhou (CN); Weide LIANG, Zhengzhou (CN); Xiangyu ZHENG, Zhengzhou (CN)

(73) Assignee: Zhengzhou University of Light Industry, Zhengzhou (CN)

(21) Appl. No.: 17/945,055

(22) Filed: Sep. 14, 2022

(30) Foreign Application Priority Data
May 5, 2022 (CN) 202210483572.4

(51) Int. Cl. H04L 47/20; H04L 45/02; H04L 47/2475; H04L 41/12; H04L 41/16

(52) U.S. Cl. CPC H04L 47/20; H04L 45/08; H04L 47/2475; H04L 41/12; H04L 41/16

(57) ABSTRACT

A method for intelligent traffic scheduling based on deep reinforcement learning, comprising: collecting flows in a data center network topology in real time, and dividing the flows into elephant flow or mice flow according to different types of flow features; establishing traffic scheduling models with energy saving and performance of the elephant flow and the mice flow as targets for joint optimization; establishing a DDPG intelligent routing traffic scheduling framework based on CNN improvement, and performing environment interaction; jointly inputting the three state messages as a state set into the CNN for training; setting an action as a comprehensive weight of energy saving and performance of each path under the condition of uniform transmission of flows in time and space, and selecting transmission paths for the elephant flow or the mice flow according to the weight; and designing reward value functions for the elephant flow and the mice flow.

### CROSS REFERENCE TO THE RELATED APPLICATION

The present application is based upon and claims priority to Chinese Patent Application No. 202210483572.4, filed on May 5, 2022, the entire content of which is hereby incorporated by reference.

### TECHNICAL FIELD

The present invention relates to the technical field of intelligent traffic scheduling, and in particular to a method for intelligent traffic scheduling based on deep reinforcement learning, which achieves energy-saving and high-performance traffic scheduling in a data center environment.

### BACKGROUND

With the rapid development of the Internet, global data center traffic increases explosively. A data center network carries thousands of services, and demands for network service traffic are non-uniformly distributed and demonstrate a large dynamic change, such that network infrastructures are facing a problem of huge energy consumption. An existing research shows that in recent years, the energy consumption of the data center network accounts for 8% of global electricity consumption, in which, the energy consumption of the network infrastructures accounts for 20% of the energy consumption of the data center. In the face of ever-complex and changeable network application services and the rapid increase of the energy consumption of network infrastructures, a conventional routing algorithm only aiming at quality of high-performance network service cannot meet the application requirements. Therefore, on the premise of guaranteeing the demand for network services, in order to reduce the influence of the high energy consumption of the network infrastructures, network energy saving optimization is also a target to be guaranteed and optimized.

Current data center traffic features show a distribution feature of elephant flow (80%-90%)/mice flow (10%-20%). The elephant flow usually has long work time and carries large data volume. The data flows in less than 1% of traffic packets can reach more than 90%, and less than 0.1% of the flows can last for 200 s. The mice flow usually has short work time and carries a small data volume. The total quantity of the mice flows reaches 80% of the total traffic quantity, and the transmission time of all the mice flows is less than 10 s. Therefore, the elephant flow and the mice flow are processed differently in traffic scheduling, and energy-saving and high-performance traffic scheduling can be realized.

### SUMMARY

Aiming at the technical problems that a conventional routing algorithm is low in instantaneity, unbalanced in resource distribution and high in energy consumption and cannot meet application requirements of existing data center networks, the present invention provides a method for intelligent traffic scheduling based on deep reinforcement learning. By using a deep deterministic policy gradient (DDPG) in the deep reinforcement learning as the energy-saving traffic scheduling framework, the convergence efficiency is improved. Flows are divided into elephant flows/mice flows for dynamic energy-saving scheduling, thus effectively improving the energy-saving percentage and network performances such as delay, throughput and packet loss rate, demonstrating the important application value of the present invention in energy-saving of data center networks.

In order to achieve the above purpose, the technical scheme of the present invention is implemented as follows: Provided is a method for intelligent traffic scheduling based on deep reinforcement learning, comprising:

step I: collecting flows in a data center network topology in real time, and dividing the flows into elephant flow or mice flow according to different types of flow features;

step II: establishing traffic scheduling models with energy saving and performance of the elephant flow and the mice flow as targets for joint optimization based on the elephant flow/mice flow existing in a network traffic;

step III: establishing a deep deterministic policy gradient (DDPG) intelligent routing traffic scheduling framework convolutional neural network (CNN) improvement, and performing environment interaction based on environmental perception and deep learning decision-making ability of the deep reinforcement learning;

step IV: state mapping: collecting state messages of a link transmission rate, a link utilization rate and a link energy consumption in a data plane, and jointly inputting the three state messages as a state set into the CNN for training;

step V: action mapping: setting an action as a comprehensive weight of energy saving and performance of each path under the condition of uniform transmission of flows in time and space according to a network state and reward value feedback information, and selecting transmission paths for the elephant flow or the mice flow according to the weight; and

step VI: reward value mapping: designing reward value functions for the elephant flow and the mice flow according to a network energy saving and performance effect of the link.

In the step I, information data of a link bandwidth, a delay, a throughput and a network traffic in the network topology are collected in real time; if a bandwidth demand of a current traffic exceeds 10% of the link bandwidth, the flow is determined as the elephant flow, and otherwise the flow is determined as the mice flow.

An optimization target minϕₑₗₑₚₕₑₙₜ of the traffic scheduling model of the mice flow is:

$$min {ϕ}_{elephent} = η {{Power}_{total}}^{′} + {{τLoss}_{elephent}}^{′} + ρ \frac{1}{{{Throught}_{elephent}}^{′}} ;$$

an optimization target min ϕ_{mice} of the traffic scheduling model of the mice flow is: minϕ_{mice}=ηPowerₜₒₜₐₗ′+τLoss_{mice}′+ρDelay_{mice}′;

in the formula, η, τ and ρ represent energy saving and performance parameters of the data plane, and η, τ and ρ are all between 0 and 1; Powerₜₒₜₐₗ′ is a normalization result of total network energy consumption Powerₜₒₜₐₗ in a network traffic transmission process; Lossₑₗₑₚₕₑₙₜ′ is a normalization result of an average packet loss rate Lossₑₗₑₚₕₑₙₜ of the elephant flow; Throughtₑₗₑₚₕₑₙₜ′ is a normalization result of an average throughput Throughtₑₗₑₚₕₑₙₜ of the elephant flow; Loss_{mice}′ is an average packet loss rate Loss_{mice} of the mice flow; Delay_{mice}′ is a normalization result of an average end-to-end delay Delay_{mice} of the mice flow;

traffic transmission constraint for both the traffic scheduling model of the elephant flow and the traffic scheduling model of the mice flow is:

$${\int }_{{p}_{i}^{′}}^{{q}_{i}^{′}} {s}_{i} ( t ) dt = {c}_{i} ;$$

$${\sum }_{v ∈ Γ ( u )} ( {f}_{i}^{uv} - {f}_{i}^{vu} ) = \{ \begin{matrix}{c}_{i} , & if u = {s}_{i} \\ - {c}_{i} , & if u = {d}_{i} \\ 0 , & else\end{matrix} \} ;$$

in the formula, cᵢ is a traffic size of a flow in a transmission interval from start time p′ᵢ to end time q′ᵢ; u is a sending node of the flow; v is a receiving node of the flow; Γ(u) is a neighbor node set of the sending node u; fᵢ^{uv} is a flow sent by the node u; fᵢ^{vu} is flow received by the node v; sᵢ represents a source node of the flow; and di represents a destination node of the flow.

The total network energy consumption Powerₜₒₜₐₗ in the network traffic transmission process is:

$${Power}_{total} = {\int }_{{p}_{i}^{′}}^{{q}_{i}^{′}} {\sum }_{e ∈ {E}_{a}} ( σ + μ {r}_{e}^{a} ( t ) ) dt , {r}_{e} ( t ) = {\sum }_{j = 1}^{P} {s}_{j} ( t ) ;$$

in the formula, p′ᵢ and q′ⁱ respectively represent the start time and the end time of the flow in an actual transmission process; E_{α} represents a set of active links, i.e., links with traffic transmission; e is an element in the link set; P represents the total number of transmitted network flows in a current link; sⱼ(t) is a transmission rate of a single network flow; i refers to the i^{th} network flow; j refers to the j^{th} network flow; σ represents an energy consumption of the link in an idle state; μ represents a link rate correlation coefficient; α represents a link rate correlation index and α>1; (rₑ₁+rₑ₂)^{α}>rₑ₁^{α}+rₑ₂^{α}, wherein rₑ₁ and rₑ₂ are respectively link transmission rates of the same link at different time or of different links; 0≤rₑ(t)≤βR, wherein β is a link redundancy parameter in a range of (0, 1), and R is the maximum transmission rate of the link;

a network topology structure of the data center is a set G=(V,E,C), wherein V represents a node set of the network topology; E represents a link set of the network topology; C represents a capacity set of each link; an elephant flow set transmitted in the network topology is Flowₑₗₑₚₕₑₙₜ={fₘ|m∈N⁺}, and a mice flow set is Flow_{mice}={fₙ|n∈N⁺}, wherein m represents the number of elephant flows; n represents the number of mice flows; N⁺ represents a positive integer set; in flow fᵢ=(sᵢ,dᵢ,pᵢ,qᵢ,rᵢ), sᵢ represents a source node of the flow; dᵢ represents a destination node of the flow; pᵢ represents the start time of the flow; qᵢ represents the end time of the flow; rᵢ represents a bandwidth demand of the flow;

the average packet loss rate of the elephant flow is

$${Loss}_{elephent} = \frac{{\sum }_{i = 1}^{m} loss ( {f}_{m} )}{m} , m ∈ {N}^{+} ;$$

the average throughput of the elephant flow is

$${Throught}_{elephent} = \frac{{\sum }_{i = 1}^{m} throught ( {f}_{m} )}{m} , m ∈ {N}^{+} ;$$

the average end-to-end delay of the mice flow is

$${Delay}_{mice} = \frac{{\sum }_{i = 1}^{n} delay ( {f}_{n} )}{n} , n ∈ {N}^{+} ;$$

the average packet loss rate of the mice flow is

$${Loss}_{mice} = \frac{{\sum }_{i = 1}^{n} loss ( {f}_{n} )}{n} , n ∈ {N}^{+} ;$$

wherein delay( ) is an end-to-end delay function in the network topology; loss( ) is a packet loss rate function; throught( ) is a throughput function;

and the normalization results are

$${{Power}_{total}}^{′} = \frac{{Power}_{{total}_{i}} - {min}_{1 \leq j \leq m + n} \{ {Power}_{{total}_{j}} \}}{{max}_{1 \leq j \leq m + n} \{ {Power}_{{total}_{j}} \} - {min}_{1 \leq j \leq m + n} \{ {Power}_{{total}_{j}} \}} ;$$

$${{Loss}_{elephent}}^{′} = \frac{{Loss}_{{elephent}_{i}} - {min}_{1 \leq j \leq m} \{ {Loss}_{{elephent}_{j}} \}}{{max}_{1 \leq j \leq m} \{ {Loss}_{{elephent}_{j}} \} - {min}_{1 \leq j \leq m} \{ {Loss}_{{elephent}_{j}} \}} ;$$

$${{Throught}_{elephent}}^{′} = \frac{{Throught}_{{elephent}_{i}} - {min}_{1 \leq j \leq m} \{ {Throught}_{{elephent}_{j}} \}}{{max}_{1 \leq j \leq m} \{ {Throught}_{{elephent}_{j}} \} - {min}_{1 \leq j \leq m} \{ {Throught}_{{elephent}_{j}} \}} ;$$

$${{Delay}_{mice}}^{′} = \frac{{Delay}_{{mice}_{i}} - {min}_{1 \leq j \leq n} \{ {Delay}_{{mice}_{j}} \}}{{max}_{1 \leq j \leq n} \{ {Delay}_{{mice}_{j}} \} - {min}_{1 \leq j \leq n} \{ {Delay}_{{mice}_{j}} \}} ;$$

$${{Loss}_{mice}}^{′} = \frac{{Loss}_{{mice}_{i}} - {min}_{1 \leq j \leq n} \{ {Loss}_{{mice}_{j}} \}}{{max}_{1 \leq j \leq n} \{ {Loss}_{{mice}_{j}} \} - {min}_{1 \leq j \leq n} \{ {Loss}_{{mice}_{j}} \}} ;$$

wherein Powerₜₒₜₐₗ_{ᵢ} is a network energy consumption of the current i^{th} flow; Powerₜₒₜₐₗ_{ⱼ} is a network energy consumption of the j^{th} flow; Powerₜₒₜₐₗ′ is a value of a normalized network energy consumption of the current flow; Lossₑₗₑₚₕₑₙₜ_{ᵢ} is a packet loss rate of the current i^{th} elephant flow; Lossₑₗₑₚₕₑₙₜ_{ⱼ} is a packet loss rate of the j^{th} elephant flow; Lossₑₗₑₚₕₑₙₜ′ is a value of a normalized packet loss rate of the current elephant flow; Throughtₑₗₑₚₕₑₙₜ_{ᵢ} is a throughput of the current i^{th} elephant flow; Throughtₑₗₑₚₕₑₙₜ_{ⱼ} is a throughput of the j^{th} elephant flow; Throughtₑₗₑₚₕₑₙₜ′ is a value of a normalized throughput of the current elephant flow; Delay_{mice}_{ᵢ} is a delay of the current i^{th} mice flow; Delay_{mice}_{ⱼ} is a delay of the j^{th} mice flow; Delay_{mice}′ is a value of a normalized delay of the current mice flow; Loss_{mice}_{ᵢ} is a packet loss rate of the current i^{th} mice flow; Loss_{mice}_{ⱼ} is a packet loss rate of the j^{th} mice flow; Loss_{mice}′ represents a value of a normalized packet loss rate of the current mice flow.

In the DDPG intelligent routing traffic scheduling framework based on CNN improvement, a conventional neural network in the DDPG is replaced with the CNN, such that a CNN update process is merged with an online network and a target network in the DDPG.

An update process of the online network and the target network in the DDPG and an interaction process with the environment are as follows:

firstly, updating the online network, the online network comprising an Actor online network and a Critic online network, wherein the Actor online network generates a current action αₜ=μ(sₜ|θ^{μ}), i.e., a link weight set, according to a state sₜ and a random initialization parameter θ^{μ} of the link transmission rate, the link utilization rate and the link energy consumption, and interacts with the environment to acquire a reward value rₜ and a next state sₜ₊₁; the state sₜ and the action αₜ are jointly input into the Critic online network, and the Critic online network iteratively generates a current action value function Q(sₜ,αₜ|θ^{Q}), wherein θ^{Q} is a random initialization parameter; the Critic online network provides gradient information grad[Q] for the Actor online network and helps the Actor online network to update the network; and

then updating the target network, wherein the Actor target network selects a next-time state sₜ₊₁ from an experience replay buffer tuple (sₜ,αₜ,rₜ,sₜ₊₁), and obtains a next optimal action at, αₜ₊₁=μ′(sₜ₊₁) through iterative training, wherein μ′ represents a deterministic behavior policy function; the network parameter θ^{μ′} is obtained by regularly copying an Actor online network parameter θ^{μ}; the action αₜ₊₁ and the state sₜ₊₁ are jointly input into the Critic target network; the Critic target network performs iterative training to obtain a target value function Q′(sₜ₊₁, μ′(sₜ₊₁|θ^{μ′})|θ^{Q′}); the parameter θ^{Q′} is obtained by regularly copying an Actor online network parameter θ^{Q}.

The Critic online network updates the network parameters with a minimum calculation error through an error equation, and the error is

$$L = \frac{1}{N} {{å}_{t} ( {y}_{t} - Q ( {s}_{t} , {a}_{t} \vert {θ}^{Q} ) )}^{2} ,$$

wherein yₜ is a target return value calculated by the Critic target network; L is a mean square error; N is the number of random samples from the experience replay buffer.

The Critic target network provides the target return value yₜ=rₜ+γQ′(sₜ₊₁, μ′(sₜ₊₁|θ^{μ′})|θ^{Q′}) for the Critic online network, and γ represents a discount factor.

The action set in the step V is Action={α_{w1}, α_{w2}, . . . α_{wi}, . . . , α_{wz}}, wi∈W;

wherein W is an optional transmission path set of network traffic; =wi represents the wi^{th} path in the optional transmission path set; α_{wi} represents an action value in the action set and refers to a path weight value of the wi^{th} path;

if the network traffic is detected to be the elephant flow, the traffic is transmitted in a multipath manner, and the elephant flow is distributed according to proportions of different link weights in a total link weight;

if the network traffic is detected to be the mice flow, the traffic is transmitted in a single-path manner; a path with a large link weight is selected as a traffic transmission path, i.e., a path with the maximum link weight is selected as a transmission path for the mice flow through the action set.

An implementation method of the step IV comprises: mapping state elements in the state set into a state feature of the CNN; selecting a link transmission rate S_{LR}_{ₜ}={lr₁(t),lr₂(t), . . . lrₘ(t)} as a state feature input feature₁, a link utilization rate state S_{LUR}_{ₜ}={lur₁(t),lur₂(t), . . . lurₘ(t)} as a state feature input feature₂ and a link energy consumption s_{LP}_{ₜ}={lp₁(t),lp₂(t), . . . lpₘ(t)} as a state feature input feature₃, wherein lr₁(t),lr₂(t), . . . lrₘ(t) respectively represent the transmission rates of the m links at time t; lur₁(t),lur₂(t), . . . lurₘ(t) respectively represent the utilization rates of the m links at time t; lp₁(t),lp₂(t), . . . lpₘ(t) respectively represent the energy consumption of the m links at time t.

The proportion calculation method comprises: in a traffic transmission from the source node s to the target node d through n paths, calculating a traffic distribution proportion

$${Proportion}_{i} = \frac{{a}_{wi}}{{\sum }_{i = 1}^{n} {a}_{wi}}$$

of each path from the source node s to the target node d.

The reward value function of the elephant flow is:

$${Reward}_{elephent} = η \frac{1}{{{Power}_{total}}^{′}} + τ \frac{1}{{{Loss}_{elephent}}^{′}} + {{ρThrought}_{elephent}}^{′} ;$$

the reward value function of the mice flow is:

$${Reward}_{mice} = η \frac{1}{{{Power}_{total}}^{′}} + τ \frac{1}{{{Loss}_{mice}}^{′}} + ρ \frac{1}{{{Delay}_{mice}}^{′}} ;$$

wherein the sum of reward value factor parameters η, τand ρ is 1; Powerₜₒₜₐₗ′ is a normalization result of the total network energy consumption Powerₜₒₜₐₗ in the flow transmission process; Lossₑₗₑₚₕₑₙₜ′ is a normalization result of the average packet loss rate Lossₑₗₑₚₕₑₙₜ of the elephant flow; Throughtₑₗₑₚₕₑₙₜ′ is a normalization result of the average throughput Throughtₑₗₑₚₕₑₙₜ of the elephant flow; Loss_{mice}′ is an average packet loss rate Loss_{mice} of the mice flow; Delay_{mice}′ is a normalization result of the average end-to-end delay Delay_{mice} of the mice flow.

Compared with the prior art, the present invention has the following beneficial effects: In order to jointly optimize the network energy saving and performance of a data plane on the basis of a software defined network technology, scheduling energy saving and performance optimization models for elephant flow and mice flow are designed. Reference is made to the DDPG in the deep reinforcement learning as an energy-saving traffic scheduling framework, and a CNN is introduced in a DDPG training process to achieve continuous traffic scheduling and optimization for the energy saving and performance. The present invention has better convergence efficiency by adopting of the DDPG based on CNN improvement. By combining environmental features such as the link transmission rate, the link utilization rate and the link energy consumption in the data plane, the present invention divides the flows into elephant flows and the mice flows for traffic scheduling, and takes the energy saving and packet loss rate of traffic transmission as targets for joint optimization according to the high-throughput demand of the elephant flow and the low-delay demand of the mice flow, such that the flows are uniformly transmitted in time and space. Compared with the routing algorithm DQN-EER, the energy saving percentage is increased by 13.93%. Compared with the routing algorithm EARS, the delay is reduced by 13.73%, the throughput is increased by 10.91% and the packet loss rate is reduced by 13.51%.

### BRIEF DESCRIPTION OF THE DRAWINGS

In order to more clearly illustrate the technical solutions in the embodiments of the present invention or in the prior art, the drawings required to be used in the description of the embodiments or the prior art are briefly introduced below. It is obvious that the drawings in the description below are some embodiments of the present invention, and those of ordinary skilled in the art can obtain other drawings according to the drawings provided herein without creative efforts.

FIG. 1 is a schematic flowchart of the present invention.

FIG. 2 is a schematic diagram of an architecture of the intelligent routing traffic scheduling under a software defined network (SDN) of the present invention.

FIG. 3 is a schematic diagram of a DDPG intelligent routing traffic scheduling framework based on CNN improvement of the present invention.

FIG. 4 is a schematic diagram of state feature mapping of the intelligent traffic scheduling of the present invention.

FIGS. 5A-5D show comparison diagrams of the energy saving effect of the intelligent traffic scheduling of the present invention under different traffic intensities, wherein FIG. 5A shows a 20% traffic intensity, FIG. 5B shows a 40% traffic intensity, FIG. 5C shows a 60% traffic intensity, and FIG. 5D shows an 80% traffic intensity.

FIGS. 6A-6C show comparison diagrams of the network performance of intelligent traffic scheduling of the present invention under different traffic intensities, wherein FIG. 6A shows delay comparison, FIG. 6B shows throughput, and FIG. 6C shows packet loss rate.

### DETAILED DESCRIPTION OF THE EMBODIMENTS

The technical schemes in the embodiments of the present invention will be clearly and completely described below with reference to the drawings in the embodiments of the present invention, and it is obvious that the described embodiments are only a part of the embodiments of the present invention but not all of them. Based on the embodiments of the present invention, all other embodiments obtained by those skilled in the art without creative effort shall fall within the protection scope of the present invention.

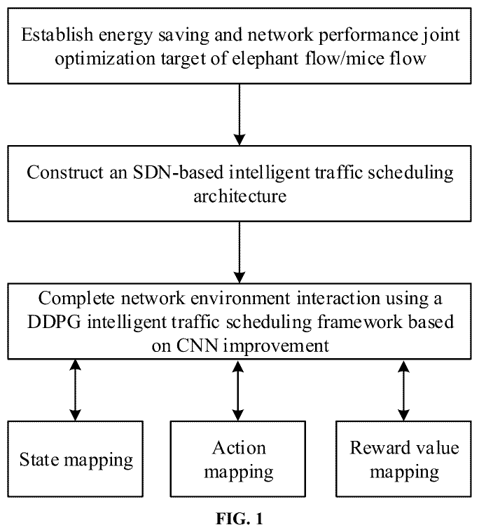

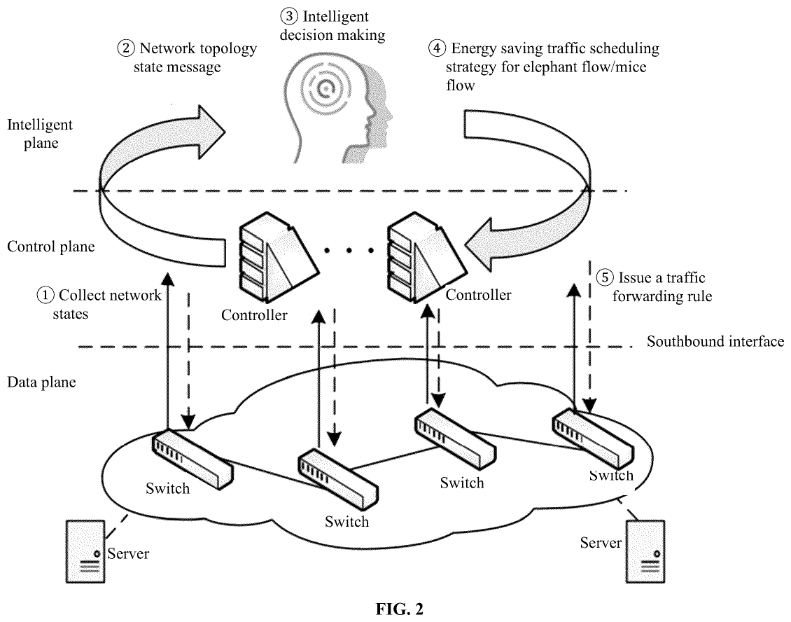

For the problems that routing optimization of existing routing algorithms is achieved only through the quality of network service and the user experience quality, and the energy consumption of a data center network is ignored, the present invention provides a method for intelligent traffic scheduling based on deep reinforcement learning, and the flow of the method is shown in FIG. 1. The present invention can acquire information data of a link bandwidth, a delay, a throughput and network traffic in a network topology in real time through southbound interfaces (using an openflow protocol) regularly by using a network detection module of a control plane in an SDN, and effectively monitor feature identification (elephant flow/mice flow) of the network traffic; if a bandwidth demand of a current traffic exceeds 10% of the link bandwidth, the flow is determined as the elephant flow, and otherwise the flow is determined as the mice flow; energy saving and performance of the data plane are used as targets for joint optimization in a deep reinforcement learning (DRL) training process of an intelligent plane; intelligent traffic scheduling models of the elephant flow and the mice flow are established, and a DDPG is used as a deep learning framework to achieve continuous high-efficiency traffic scheduling of the targets for joint optimization; the training process is based on a CNN and can effectively improve the convergence efficiency of a system by utilizing the advantages of local perception and parameter sharing of the CNN; after the training is converged, high-efficiency link weights of the elephant flow and the mice flow are output to achieve dynamic energy saving and performance scheduling of a route; a traffic table rule is issued by an SDN controller to the data plane. A high-efficiency traffic scheduling architecture under the SDN is as shown in FIG. 2, including a data plane, a control plane and an intelligent plane; a switch and a server are arranged in the data plane and the switch is in communicative connection to the controller and the server. A controller is arranged in the control plane and used for collecting network state parameters of the data plane; the intelligent plane establishes state information of a network topology and implements intelligent decision making to achieve an elephant flow/mice flow energy saving traffic scheduling strategy; the control plane issues a traffic forwarding rule to the switch. Procedures of the specific workflow of the present invention are as follows:

Step I: collecting data flows in a data center network topology in real time, and dividing the data flows into elephant flow or mice flow.

Step II: establishing intelligent traffic scheduling models with energy saving and performance as targets for joint optimization based on the elephant flow/mice flow existing in a network traffic.

The present invention takes traffic scheduling of a data center as an example. The network traffic in the conventional data center adopts unified traffic scheduling, without distinguishing elephant flow and mice flow, which inevitably causes the problems of low scheduling instantaneity, unbalanced resource distribution, high energy consumption and the like. In order to ensure the balance of traffic in user services, the present invention further divides the traffic into elephant flow/mice flow for dynamic scheduling. Therefore, according to different types of traffic features, different optimization methods are established for the elephant flow and the mice flow so as to achieve intelligent traffic scheduling of the elephant flow and the mice flow.

In the present invention, when the network topology of the data center is confirmed, and activation and dormancy of the links and the switches are clear, energy saving traffic scheduling is performed. On this basis, a network energy consumption model can be simplified into a link rate level energy consumption model, and a link power consumption function is recorded as Power(rₑ), wherein rₑ(t) is a link transmission rate. The calculation process is as shown in formula (1).

Power(rₑ)=σ+μrₑ^{α}(t), 0≤rₑ≤βr (1)

In the formula, σ represents an energy consumption of the link in an idle state; μ represents a link rate correlation coefficient; α represents a link rate correlation index and α>1; (rₑ₁+rₑ₂)^{α}>rₑ₁^{α}+rₑ₂^{α}, wherein rₑ₁ and rₑ₂ are respectively link transmission rates of the same link at different time or of different links; Power(□) can be superimposed; β is a link redundancy parameter in a range of (0,1), and R is the maximum transmission rate of the link. Therefore, it can be seen from formula (1) that the link energy consumption is minimized when the traffic is uniformly transmitted in time and space. A calculation process of the total network energy consumption Powerₜₒₜₐₗ in the network traffic transmission process is shown in formula (2).

$${Power}_{total} = {\int }_{{p}_{i}^{′}}^{{q}_{i}^{′}} {\sum }_{e ∈ {E}_{a}} ( σ + μ {r}_{e}^{a} ( t ) ) dt , \qquad ( 2 )$$

$${r}_{e} ( t ) = {\sum }_{j = 1}^{P} {S}_{j} ( t )$$

In the formula, p′ᵢ and q′ᵢ respectively represent the start time and the end time of the flow in an actual transmission process; E_{α} represents a set of active links, i.e., links with traffic transmission; e is an element in the link set, which can be used as one edge in the network topology; P represents the total number of transmitted network flows in a current link; sⱼ(t) is a transmission rate of a single network flow; i refers to the i^{th} network flow; and j refers to the j^{th} network flow.

The network topology structure of the data center is defined as a set G=(V,E,C), wherein V represents a node set of the network topology; E represents a link set of the network topology; C represents a capacity set of each link. It is assumed that the elephant flow set transmitted in the network topology is Flowₑₗₑₚₕₑₙₜ={fₘ|m∈N⁺}, and the mice flow set is Flow_{mice}={fₙ|n∈N⁺}, wherein m represents the number of elephant flows and n represents the number of mice flows. In flow fᵢ=(sᵢ,dᵢ,pᵢ,qᵢ,rᵢ), sᵢ represents a source node of the flow; dᵢ represents a destination node of the flow; pᵢ represents the start time of the flow; qᵢ represents the end time of the flow; rᵢ represents a bandwidth demand of the flow. An end-to-end delay in the network topology is recorded as delay(x); a packet loss rate is recorded as loss(x); a throughput is recorded as throught(x); and x represents a variable, which refers to the network flow. Calculation processes of an average packet loss rate Lossₑₗₑₚₕₑₙₜ and an average throughput Throughtₑₗₑₚₕₑₙₜ of the elephant flow and an average end-to-end delay Delay_{mice} and an average packet loss rate Loss_{mice} of the mice flow are respectively shown in formulas (3), (4), (5) and (6).

$${Loss}_{elephent} = \frac{{\sum }_{i = 1}^{m} loss ( {f}_{m} )}{m} , m ∈ {N}^{+} \qquad ( 3 )$$

$${Throught}_{elephent} = \frac{{\sum }_{i = 1}^{m} throught ( {f}_{m} )}{m} , m ∈ {N}^{+} \qquad ( 4 )$$

$${Delay}_{elephent} = \frac{{\sum }_{i = 1}^{n} delay ( {f}_{n} )}{n} , n ∈ {N}^{+} \qquad ( 5 )$$

$${Loss}_{mice} = \frac{{\sum }_{i = 1}^{n} loss ( {f}_{n} )}{n} , n ∈ {N}^{+} \qquad ( 6 )$$

The optimization target of the present invention is the energy saving and performance routing traffic scheduling of the data plane. Main optimization targets include: (1) weighted minimum values of reciprocals of the network energy consumption and the average packet loss rate and throughput of the elephant flow; and (2) weighted minimum values of the network energy consumption and the average packet loss rate and average end-to-end delay of the mice flow. In order to simplify the calculation method, dimensional expressions are converted into table quantities, i.e., normalization of energy saving and performance parameters of the data plane. Calculation processes are shown in formulas (7), (8), (9), (10) and (11).

$${Power}_{total}^{′} = \frac{{Power}_{{total}_{i}} - {min}_{1 \leq j \leq n} \{ {Power}_{{total}_{j}} \}}{{max}_{1 \leq j \leq n} \{ {Power}_{{total}_{j}} \} - {min}_{1 \leq j \leq n} \{ {Power}_{{total}_{j}} \}} \qquad ( 7 )$$

$${Loss}_{elephent}^{′} = \frac{{Loss}_{{elephent}_{i}} - {min}_{1 \leq j \leq n} \{ {Loss}_{{elephent}_{j}} \}}{{max}_{1 \leq j \leq n} \{ {Loss}_{{elephent}_{j}} \} - {min}_{1 \leq j \leq n} \{ {Loss}_{{elephent}_{j}} \}} \qquad ( 8 )$$

$${Throught}_{elephent}^{′} = \frac{{Throught}_{{elephent}_{i}} - {min}_{1 \leq j \leq n} \{ {Throught}_{{elephent}_{i}} \}}{{max}_{1 \leq j \leq n} \{ {Throught}_{{elephent}_{i}} \} - {min}_{1 \leq j \leq n} \{ {Throught}_{{elephent}_{i}} \}} \qquad ( 9 )$$

$${Delay}_{mice}^{′} = \frac{{Delay}_{{mice}_{i}} - {min}_{1 \leq j \leq n} \{ {Delay}_{{mice}_{j}} \}}{{max}_{1 \leq j \leq n} \{ {Delay}_{{mice}_{j}} \} - {min}_{1 \leq j \leq n} \{ {Delay}_{{mice}_{j}} \}} \qquad ( 10 )$$

$${Loss}_{mice}^{′} = \frac{{Loss}_{{mice}_{i}} - {min}_{1 < j < n} \{ {Loss}_{{mice}_{j}} \}}{{max}_{1 \leq j \leq n} \{ {Loss}_{{mice}_{j}} \} - {min}_{1 \leq j \leq n} \{ {Loss}_{{mice}_{j}} \}} \qquad ( 11 )$$

In the formula, Powerₜₒₜₐₗ_{ᵢ} is a network energy consumption of the current flow; Powerₜₒₜₐₗ_{ⱼ} is a network energy consumption set of all flows; Powerₜₒₜₐₗ′ is a value of a normalized network energy consumption of the current flow; Lossₑₗₑₚₕₑₙₜ_{ᵢ} is a packet loss rate of the current elephant flow; Lossₑₗₑₚₕₑₙₜ_{ⱼ} is a packet loss rate set of all elephant flows; Lossₑₗₑₚₕₑₙₜ′ is a value of a normalized packet loss rate of the current elephant flow; Throughtₑₗₑₚₕₑₙₜ_{ᵢ} is a throughput of the current elephant flow; Throughₑₗₑₚₕₑₙₜ_{ⱼ} is a throughput set of all elephant flows; Throughtₑₗₑₚₕₑₙₜ′ is a value of a normalized throughput of the current elephant flow; Delay_{mice}_{ᵢ} is a delay of the current mice flow; Delay_{mice}_{ⱼ} is a delay set of all mice flows; Delay_{mice}′ is a value of a normalized delay of the current mice flow; Loss_{mice}_{ᵢ} is a packet loss rate of the current mice flow; Loss_{mice}_{ⱼ} is a packet loss rate set of all mice flows; Loss_{mice}′ represents a value of a normalized packet loss rate of the current mice flow.

After the normalization is completed, network energy saving and performance optimization targets minϕₑₗₑₚₕₑₙₜ and minϕ_{mice} for elephant flow and mice flow scheduling are established, and the calculation processes are shown in formulas (12) and (13).

$$min {ϕ}_{elephent} = η {Power}_{total}^{′} + τ {Loss}_{elephent}^{′} + ρ \frac{1}{{Throught}_{elephent}^{′}} \qquad ( 12 )$$

$$min {ϕ}_{mice} = η {Power}_{total}^{′} + τ {Loss}_{mice}^{′} + ρ {Delay}_{mice}^{′} \qquad ( 13 )$$

In the formula, η, τ and ρ represent energy saving and performance parameters of the data plane, and η, τ and ρ are all between 0 and 1. In order to ensure that the above traffic scheduling process is not affected by the environment, in the present invention, traffic transmission constraints are defined as shown in formulas (14) and (15).

$${\int }_{{p}_{i}^{′}}^{{q}_{i}^{′}} {s}_{i} ( t ) dt = {c}_{i} \qquad ( 14 )$$

$${\sum }_{v ∈ Γ ( u )} ( {f}_{i}^{uv} - {f}_{i}^{vu} ) = \{ \begin{matrix}{c}_{i} , & if u = {s}_{i} \\ - {c}_{i} , & if u = {d}_{i} \\ 0 & else\end{matrix} \} \qquad ( 15 )$$

In the formula, cᵢ is a traffic size of a flow in a transmission interval from start time p′ᵢ to end time q′ᵢ; u is a sending node of the flow; v is a receiving node of the flow; Γ(u) is a neighbor node set of the sending node u; fᵢ^{uv} is a flow sent by the node u; fᵢ^{vu} is flow received by the node v. sᵢ represents a source node of the flow and di represents a destination node of the flow.

Step III: establishing a deep deterministic policy gradient (DDPG) intelligent routing traffic scheduling framework convolutional neural network (CNN) improvement based on environmental perception and deep learning decision-making ability of the deep reinforcement learning.

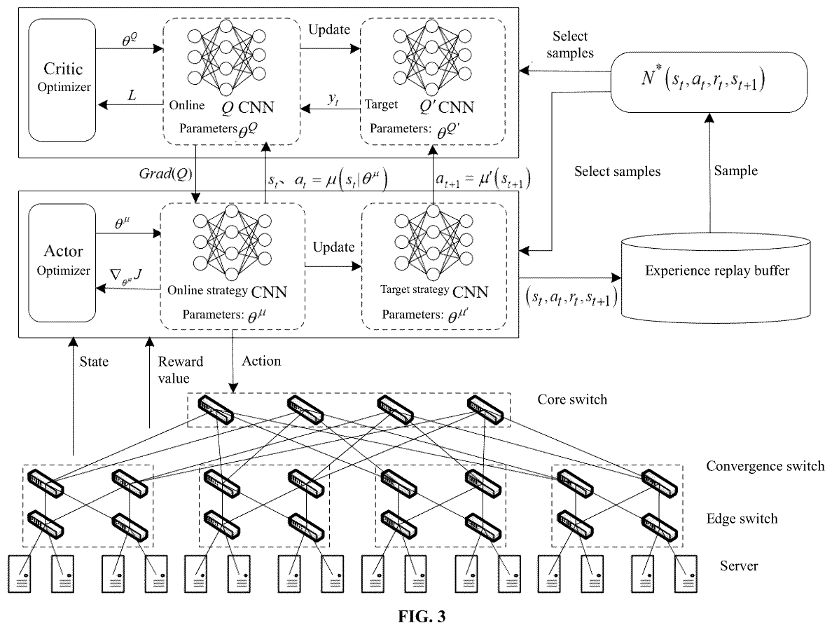

In the present invention, a conventional neural network in the DDPG is replaced with a CNN, such that a CNN update process is merged with an online network and a target network in the DDPG, and the system convergence efficiency can be effectively improved by utilizing the high-latitude data processing advantage of the CNN. The DDPG uses a Fat Tree network topology structure as a data center network environment. The DDPG intelligent routing traffic scheduling framework based on CNN improvement, as shown in FIG. 3, mainly comprises an intelligent agent and a network environment. The intelligent agent comprises Actor-Critic online networks and target networks based on CNN improvement, an experience replay buffer, and the like. The Actor-Critic online networks and target networks are connected with the experience replay buffer; the network environment comprises network devices such as a core switch, a convergence switch, an edge switch and a server; the core switch is connected with the convergence switch; the convergence switch is connected with the edge switch; the edge switch is in communicative connection with the server. Specifically, the update processes of the Actor-Critic online networks and target networks in the DDPG-based energy saving routing traffic scheduling framework and the interaction process between Actor-Critic and the environment are as follows:

Firstly, updating the online network: the online network consists of an Actor online network and a Critic online network, wherein the Actor online network generates a current action αₜ=μ(sₜ|θ^{μ}), i.e., a link weight set, according to states sₜ and random initialization parameters θ^{μ} of the link transmission rate, the link utilization rate and the link energy consumption, and interacts with the environment to acquire a reward value rₜ and a next state sₜ₊₁. The state sₜ and the action αₜ are jointly input into the Critic online network, and the Critic online network iteratively generates a current action value function Q(sₜ,αₜ|θ^{Q}), wherein θ^{Q} is a random initialization parameter. The online network Critic provides gradient information grad[Q] for the online strategy network Actor and helps the online strategy network Actor to update the network. In addition, the online strategy network Critic updates the network parameters with a minimum calculation error through an error equation. The calculation error process is shown in formula

$$L = \frac{1}{N} {å}_{t} {( {y}_{t} - Q ( {s}_{t} , {a}_{t} \vert {θ}^{Q} ) )}^{2} ,$$

wherein yₜ is a target return value calculated by the Critic target network; L is a mean square error; Nis the number of random samples from the experience replay buffer.

Secondly, updating the target network: the Actor target strategy network selects a next-time state sₜ₊₁ from an experience replay buffer tuple (sᵢ,αᵢ,rᵢ,sᵢ₊₁), and obtains a next optimal action at αₜ₊₁=μ′(sₜ₊₁) through iterative training, wherein μ′ represents a deterministic behavior policy function; the network parameter θ^{μ′} is obtained by regularly copying an Actor online strategy network parameter θ^{μ}; the action αₜ₊₁ and the state sₜ₊₁ are jointly input into the Critic target network; the Critic target network performs iterative training to obtain a target value function Q′(sₜ₊₁, μ′(sₜ₊₁|θ^{μ′})|θ^{Q′}); the parameter θ^{Q′} is obtained by regularly copying an Actor online strategy network parameter θ^{Q}. The Critic target network provides the target return value yₜ for the Critic online strategy network as calculated by the formula yₜ=rₜ+γQ′(sₜ₊₁, μ′(sₜ₊₁|θ^{μ′})|θ^{Q′}), and γ represents a discount factor. The DDPG training process is completed after the Actor-Critic online networks and target networks are updated.

Step IV: state mapping: collecting state messages of a link transmission rate, a link utilization rate and a link energy consumption in a data plane, and jointly inputting the three state features as a state set stateₜ={s_{LR}_{ₜ},s_{LUR}_{ₜ},s_{LP}_{ₜ}} into the CNN for training.

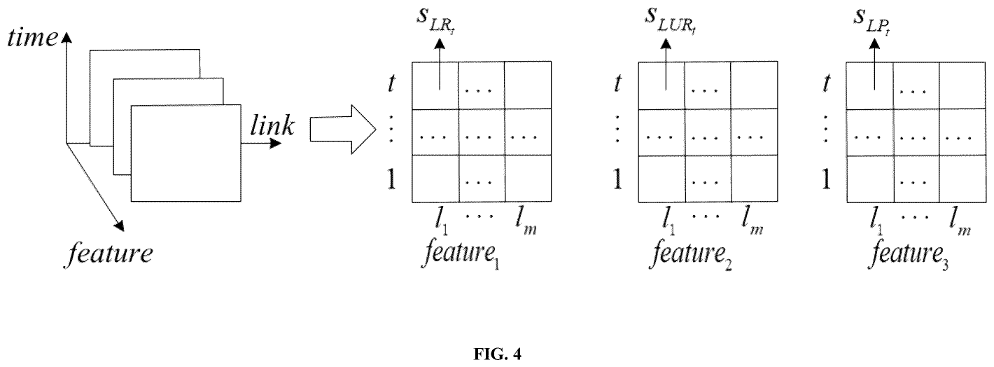

In the present invention, energy saving and network performance of the data plane are used as targets for joint optimization, which is mainly related to the link transmission rates, the link utilization rates and the link energy consumption information of the current time and the historical time. It is assumed that there are m links. In the present invention, the three state features are jointly used as a state set stateₜ={s_{LR}_{ₜ},s_{LUR}_{ₜ},s_{LP}_{ₜ}} input into the CNN for training; state elements in the state set are mapped into a state feature of the CNN, wherein the state feature mapping is shown in FIG. 4, a link transmission rate s_{LR}_{ₜ}={lr₁(t),lr₂(t), . . . lrₘ(t)} is selected as a state feature input feature₁, a link utilization rate state S_{LUR}_{ₜ}={lur₁(t),lur₂(t), . . . lurₘ(t)} is selected as a state feature input feature₂ and a link energy consumption s_{LP}_{ₜ}={lp₁(t),lp₂(t), . . . lpₘ(t)} is selected as a state feature input feature₃, wherein lr₁(t),lr₂(t), . . . lrₘ(t) respectively represent the transmission rates of the m links at time t; lur₁(t),lur₂(t), . . . lurₘ(t) respectively represent the utilization rates of the m links at time t; lp₁(t),lp₂(t), . . . lpₘ(t) respectively represent the energy consumption of the m links at time t. After the mapping of feature₁, feature₂ and feature₃ is completed, the mapping is used to reflecting the current network condition, and the CNN training can be finished by means of the network state feature inputs.

Step V: action mapping: setting actions of the elephant flow and the mice flow as a comprehensive weight of energy saving and performance of each link under the condition of uniform transmission of flows in time and space.

The present invention sets the actions as a comprehensive weight of performance and energy saving of each link under the condition of uniform transmission of flows in time and space according to a network state and reward value feedback information. A specific action set is shown in formula (16).

Action={α_{w1},α_{w2}, . . . α_{wi}, . . . , α_{w2}}wi∈W (16)

In the formula, W is an optional transmission path set of network traffic; =wi represents the wi^{th} path in the optional transmission path set; α_{wi} represents an action value in the action set and refers to a path weight value of the wi^{th} path; z represents the total number of optional transmission paths. In the present invention, flows are divided into the elephant flow and the mice flow for traffic scheduling. As such, if the controller (arranged in the control plane) detects that the network traffic is an elephant flow, the traffic transmission is conducted in a multipath manner, and the elephant flow is distributed according to proportions of different link weights in a total link weight. For example, a traffic transmission may be conducted from a certain source node s to a target node d through n paths, that is, a traffic distribution proportion of each path from the source node s to the target node d can be calculated through formula

$${Proportion}_{i} = \frac{{a}_{wi}}{{\sum }_{i = 1}^{n} {a}_{wi}} ;$$

if the controller detects that the network traffic is the mice flow, the traffic is transmitted in a single-path manner. A path with a large link weight is selected as a traffic transmission path, i.e., a path with the maximum link weight is selected from the action set {α_{w1},α_{w2}, . . . α_{wi}, . . . , α_{wn}} as a transmission path for the mice flow.

Step VI: reward value mapping: designing reward value functions or reward value accumulation standards for the elephant flow and the mice flow according to a network energy saving and performance effect of the link.

In consideration of the features of different data flows, the reward value functions of the elephant flow and the mice flow are set. Main optimization targets of the elephant flow are low energy consumption, low packet loss rate and high throughput. As such, values of normalized energy consumption, packet loss rate and throughput are used as reward value factors. A smaller optimization target indicates a larger reward value. In order to directly read accumulated reward value gains, reciprocals of the energy consumption and the packet loss rate are selected as reward value factors during setting of a reward value. A specific calculation process is shown in formula (17).

$${Reward}_{elephent} = η \frac{1}{{Power}_{total}^{′}} + τ \frac{1}{{Loss}_{elephent}^{′}} + ρ {Throught}_{elephent}^{′} \qquad ( 17 )$$

In the formula, the reward value factor parameters η, τ and ρ are all between 0 and 1, including 0 and 1. A parameter represents a ratio of one element in the formula, which can be selected according to proportions of the importance of the energy consumption, the packet loss rate and the throughput in the elephant flow. Similarly, the mice flow takes low energy consumption, low packet loss rate and low delay as the optimization targets, and reciprocals of three normalized elements are used as reward value factors. A specific calculation process is shown in formula (18).

$${Reward}_{mice} = η \frac{1}{{Power}_{total}^{′}} + τ \frac{1}{{Loss}_{mice}^{′}} + ρ \frac{1}{{Delay}_{elephent}^{′}} \qquad ( 18 )$$

After the training is converged, the method further tests the convergence, the energy saving percentage, the delay, the throughput, the packet loss rate and the like of the system.

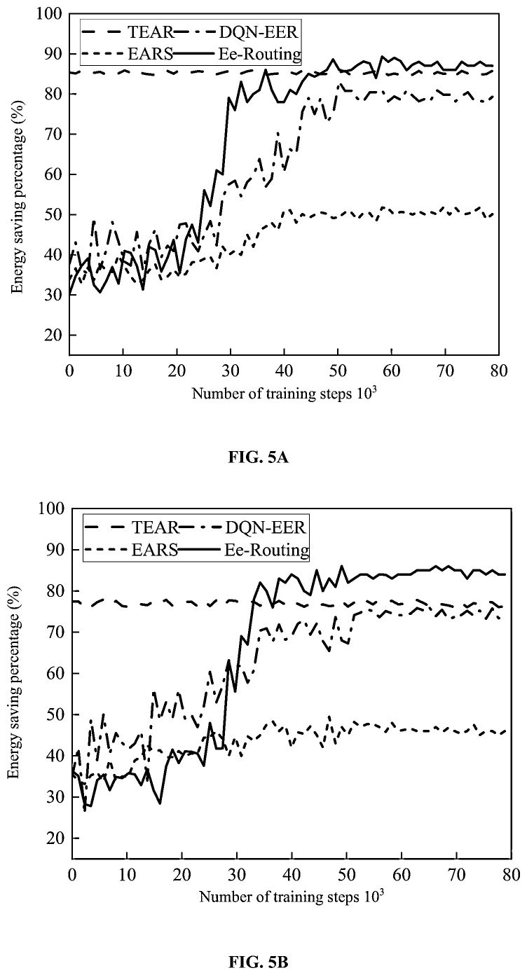

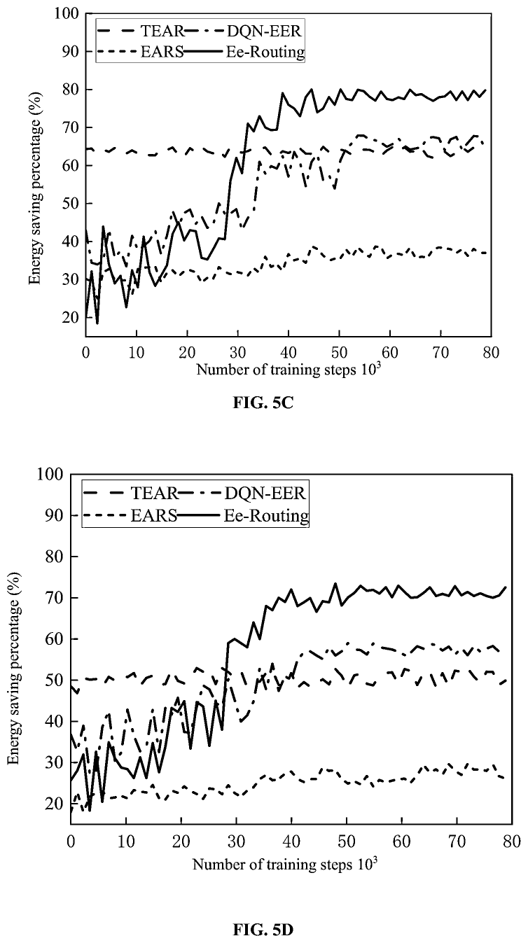

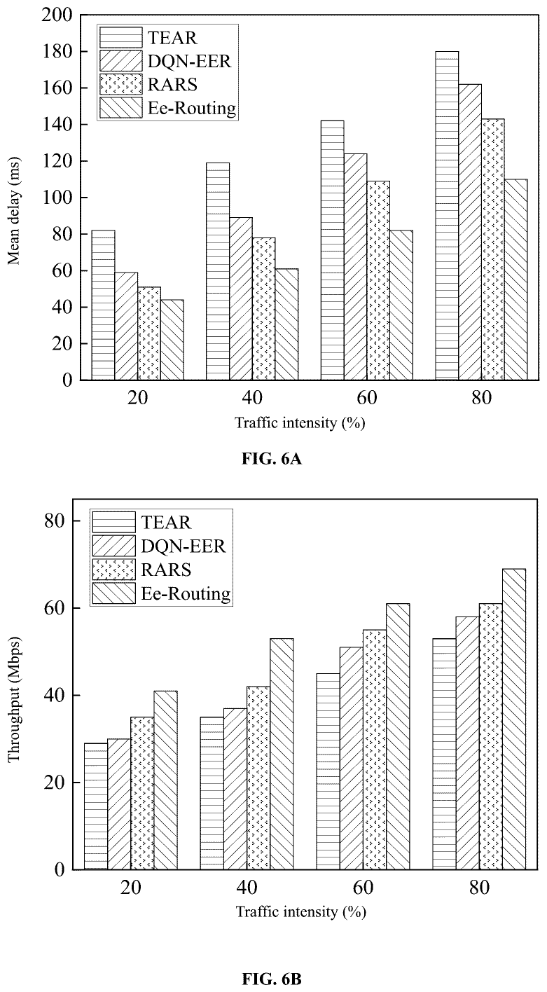

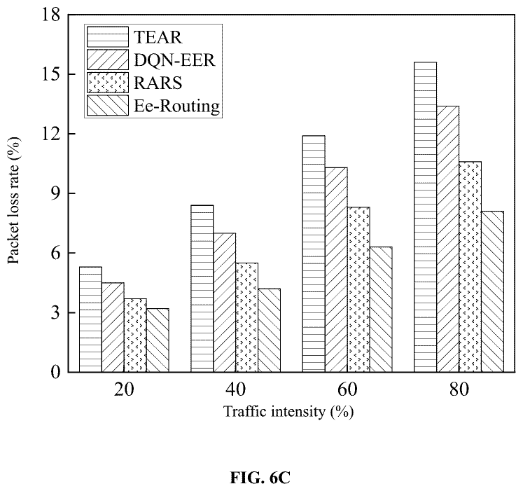

In order to test the energy saving and network performance advantages of the method for intelligent traffic scheduling disclosed herein, in the testing processes, the present invention is compared with an existing good energy saving routing algorithm, high-performance intelligent routing algorithm and heuristic energy-saving routing algorithm. An energy-saving effect evaluation index is shown in formula

$${Power}_{save} = 1 - \frac{{lp}_{i}}{{lp}_{full}} \times 100 \% ,$$

wherein lpᵢ represents the network link energy consumption consumed by the current routing algorithm, and lp_{full} is the total link energy consumption consumed under a full load of the link. In order to test the energy saving and network performance effects of the present invention in a real network scenario, network load environments with different traffic intensities are set in the test process. The network energy consumption, the delay, the throughput and the packet loss rate are used as optimization targets. In the process of testing energy saving, the parameter weight η is set as 1, and the parameter weights τ and ρ are set as 0.5. In the process of testing performance, the parameter weight η is set as 0.5, and the parameter weights τ and ρ are set as 1; in the energy consumption function, α is set as 2, and μ is set as 1; and periodic traffics are set as 20%,40%, 60% and 80%. Test results are shown in FIGS. 5A-5D and 6A-6C, wherein TEAR refers to Time Efficient Energy Aware Routing; DQN-EER refers to Deep Q-Network-based Energy-Efficient Routing; EARS refers to Intelligence-Driven Experiential Network Architecture for Automatic Routing in Software-Defined Networking. As can be seen from FIGS. 5A-5D and 6A-6C, after the Ee-Routing training of the method disclosed herein tends to be stable, compared with that of conventional intelligent routing algorithm DQN-EER with good energy saving, the energy saving percentage is increased by 13.93%, and the method has better convergence. The process (i.e., the convergence process) that the Ee-Routing tends to be stable is fast and short in time. Compared with those of conventional intelligent routing algorithm EARS with good energy saving, the delay is reduced by 13.73%, the throughput is reduced by 10.91%, and the packet loss rate is reduced by 13.51%.

The above mentioned contents are only preferred embodiments of the present invention and are not intended to limit the present invention. Any modification, equivalent substitution, improvement, etc., made within the spirit and principle of the present invention shall all fall within the scope of protection of the present invention.

1. A method for an intelligent traffic scheduling based on a deep reinforcement learning, comprising:
step I: collecting flows in a data center network topology in real time, and dividing the flows into an elephant flow or a mice flow according to different types of flow features;
step II: establishing a traffic scheduling model with energy saving and performance of the elephant flow and the mice flow as targets for a joint optimization based on the elephant flow or the mice flow existing in a network traffic;
step III: establishing a deep deterministic policy gradient (DDPG) intelligent routing traffic scheduling framework based on a convolutional neural network (CNN) improvement, and performing an environment interaction based on an environmental perception and a deep learning decision-making ability of the deep reinforcement learning;
step IV: state mapping: collecting state messages of a link transmission rate, a link utilization rate, and a link energy consumption in a data plane, and jointly inputting the three state messages as a state set into a CNN for training;
step V: action mapping: setting an action as a comprehensive weight of energy saving and performance of each path under a condition of uniform transmission of flows in time and space according to a network state and reward value feedback information, and selecting transmission paths for the elephant flow or the mice flow according to the comprehensive weight; and
step VI: reward value mapping: designing reward value functions for the elephant flow and the mice flow according to a network energy saving and performance effect of a link.

2. The method for the intelligent traffic scheduling based on the deep reinforcement learning according to claim 1, wherein in the step I, information data of a link bandwidth, a delay, a throughput, and the network traffic in the data center network topology are collected in real time; if a bandwidth demand of a current traffic exceeds 10% of the link bandwidth, the flow is determined as the elephant flow, and otherwise the flow is determined as the mice flow.

3. The method for the intelligent traffic scheduling based on the deep reinforcement learning according to claim 1, wherein an optimization target minϕₑₗₑₚₕₑₙₜ of the traffic scheduling model for the elephant flow is:
$$min {ϕ}_{elephent} = η {Power}_{total}^{′} + τ {Loss}_{elephent}^{′} + ρ \frac{1}{{Throught}_{elephent}^{′}} ;$$
an optimization target minϕ_{mice} of the traffic scheduling model of the mice flow is: minϕ_{mice}=ηPowerₜₒₜₐₗ′+τLoss_{mice}′+ρDelay_{mice}′;
in the formula, η, τ and ρ represent energy saving and performance parameters of the data plane, and η, τ and ρ are all between 0 and 1; Powerₜₒₜₐₗ′ is a normalization result of total network energy consumption Powerₜₒₜₐₗ in a network traffic transmission process; Lossₑₗₑₚₕₑₙₜ′ is a normalization result of an average packet loss rate Lossₑₗₑₚₕₑₙₜ of the elephant flow; Throughtₑₗₑₚₕₑₙₜ′ is a normalization result of an average throughput Throughtₑₗₑₚₕₑₙₜ of the elephant flow; Loss_{mice}′ is an average packet loss rate Loss_{mice} of the mice flow; Delay_{mice}′ is a normalization result of an average end-to-end delay Delay_{mice} of the mice flow;
a traffic transmission constraint for both the traffic scheduling model of the elephant flow and the traffic scheduling model of the mice flow is:
$${\int }_{{p}_{i}^{′}}^{{q}_{i}^{′}} {s}_{i} ( t ) dt = {c}_{i} ;$$
$${\sum }_{v ∈ Γ ( u )} ( {f}_{i}^{uv} - {f}_{i}^{vu} ) = \{ \begin{matrix}{c}_{i} , & if u = {s}_{i} \\ - {c}_{i} , & if u = {d}_{i} \\ 0 & else\end{matrix} \} ;$$
in the formula, cᵢ is a traffic size of a flow in a transmission interval from start time p′ᵢ to end time q′ᵢ; u is a sending node of the flow; v is a receiving node of the flow; Γ(u) is a neighbor node set of the sending node u; fᵢ^{uv} is a flow sent by the sending node u; fᵢ^{vu} is flow received by the receiving node v; sᵢ represents a source node of the flow; and dᵢ represents a destination node of the flow.

4. The method for the intelligent traffic scheduling based on the deep reinforcement learning according to claim 2, wherein an optimization target minϕₑₗₑₚₕₑₙₜ of the traffic scheduling model for the elephant flow is:
$$min {ϕ}_{elephent} = η {Power}_{total}^{′} + τ {Loss}_{elephent}^{′} + ρ \frac{1}{{Throught}_{elephent}^{′}} ;$$
an optimization target minϕ_{mice} of the traffic scheduling model of the mice flow is: minϕ_{mice}=ηPowerₜₒₜₐₗ′+τLoss_{mice}′+ρDelay_{mice}′;
in the formula, η, τ and ρ represent energy saving and performance parameters of the data plane, and η, τ and ρ are all between 0 and 1; Powerₜₒₜₐₗ′ is a normalization result of total network energy consumption Powerₜₒₜₐₗ in a network traffic transmission process; Lossₑₗₑₚₕₑₙₜ′ is a normalization result of an average packet loss rate Lossₑₗₑₚₕₑₙₜ of the elephant flow; Throughtₑₗₑₚₕₑₙₜ′ is a normalization result of an average throughput Throughtₑₗₑₚₕₑₙₜ of the elephant flow; Loss_{mice}′ is an average packet loss rate Loss_{mice} of the mice flow; Delay_{mice}′ is a normalization result of an average end-to-end delay Delay_{mice} of the mice flow;
a traffic transmission constraint for both the traffic scheduling model of the elephant flow and the traffic scheduling model of the mice flow is:
$${\int }_{{p}_{i}^{′}}^{{q}_{i}^{′}} {s}_{i} ( t ) dt = {c}_{i} ;$$
$${\sum }_{v ∈ Γ ( u )} ( {f}_{i}^{uv} - {f}_{i}^{vu} ) = \{ \begin{matrix}{c}_{i} , & if u = {s}_{i} \\ - {c}_{i} , & if u = {d}_{i} \\ 0 & else\end{matrix} \} ;$$
in the formula, cᵢ is a traffic size of a flow in a transmission interval from start time p′ᵢ to end time q′ᵢ; u is a sending node of the flow; v is a receiving node of the flow; Γ(u) is a neighbor node set of the sending node u; fᵢ^{uv} is a flow sent by the sending node u; fᵢ^{vu} is flow received by the receiving node v; sᵢ represents a source node of the flow; and dᵢ represents a destination node of the flow.

5. The method for the intelligent traffic scheduling based on the deep reinforcement learning according to claim 3, wherein the total network energy consumption Powerₜₒₜₐₗ in the network traffic transmission process is:
$${Power}_{total} = {\int }_{{p}_{i}^{′}}^{{q}_{i}^{′}} {\sum }_{e ∈ {E}_{a}} ( σ + μ {r}_{e}^{a} ( t ) ) dt ,$$
$${r}_{e} ( t ) = {\sum }_{j = 1}^{P} {s}_{j} ( t ) ;$$
in the formula, p′ᵢ and q′ᵢ respectively represent the start time and the end time of the flow in an actual transmission process; E_{α} represents a set of active links with traffic transmission; e is an element in the set of active links; P represents a total number of transmitted network flows in a current link; sⱼ(t) is a transmission rate of a single network flow; i refers to an i^{th} network flow; j refers to j^{th} network flow; σ represents an energy consumption of the link in an idle state; μ represents a link rate correlation coefficient; α represents a link rate correlation index and α>1; (rₑ₁+rₑ₂)^{α}>rₑ₁^{α}+rₑ₂^{α}, wherein rₑ₁ and rₑ₂ are respectively link transmission rates of the same link at different time or of different links; 0≤rₑ(t)≤βR, wherein β is a link redundancy parameter in a range of (0, 1), and R is a maximum transmission rate of the link;
a structure of the data center network topology is a set G=(V,E,C), wherein V represents a node set of the data center network topology; E represents a link set of the data center network topology; C represents a capacity set of each link; an elephant flow set transmitted in the data center network topology is Flowₑₗₑₚₕₑₙₜ={fₘ|m∈N⁺}, and a mice flow set is Flow_{mice}={fₙ|n∈N⁺}, wherein m represents a number of elephant flows; n represents a number of mice flows; N⁺ represents a positive integer set; in a flow fᵢ=(sᵢ,dᵢ,pᵢ,qᵢ,rᵢ), sᵢ represents a source node of the flow; dᵢ represents a destination node of the flow; pᵢ represents the start time of the flow; qᵢ represents the end time of the flow; rᵢ represents a bandwidth demand of the flow;
the average packet loss rate of the elephant flow is
$${Loss}_{elephent} = \frac{{\sum }_{i = 1}^{m} loss ( {f}_{m} )}{m} , m ∈ {N}^{+} ;$$
the average throughput of the elephant flow is
$${Throught}_{elephent} = \frac{{\sum }_{i = 1}^{m} throught ( {f}_{m} )}{m} , m ∈ {N}^{+} ;$$
the average end-to-end delay of the mice flow is
$${Delay}_{mice} = \frac{{\sum }_{i = 1}^{n} delay ( {f}_{n} )}{n} , n ∈ {N}^{+} ;$$
the average packet loss rate of the mice flow is
$${Loss}_{mice} = \frac{{\sum }_{i = 1}^{n} loss ( {f}_{n} )}{n} , n ∈ {N}^{+} ;$$
wherein delay( ) is an end-to-end delay function in the data center network topology; loss( ) is a packet loss rate function; throught( ) is a throughput function;
and the normalization results are
$${Power}_{total}^{′} = \frac{{Power}_{{total}_{i}} - {min}_{1 \leq j \leq m + n} \{ {Power}_{{total}_{j}} \}}{{max}_{1 \leq j \leq m + n} \{ {Power}_{{total}_{j}} \} - {min}_{1 \leq j \leq m + n} \{ {Power}_{{total}_{j}} \}} ;$$
$${Loss}_{elephent}^{′} = \frac{{Loss}_{{elephent}_{i}} - {min}_{1 \leq j \leq m} \{ {Loss}_{{elephent}_{j}} \}}{{max}_{1 \leq j \leq m} \{ {Loss}_{{elephent}_{j}} \} - {min}_{1 \leq j \leq m} \{ {Loss}_{{elephent}_{j}} \}} ;$$
$${Throught}_{elephent}^{′} = \frac{{Throught}_{{elephent}_{i}} - {min}_{1 \leq j \leq n} \{ {Delay}_{{mice}_{j}} \}}{{max}_{1 \leq j \leq m} \{ {Throught}_{{elephent}_{j}} \} - {min}_{1 \leq j \leq m} \{ {Throught}_{{elephent}_{j}} \}} ;$$
$${Delay}_{mice}^{′} = \frac{{Delay}_{{mice}_{i}} - {min}_{1 \leq j \leq n} \{ {Delay}_{{mice}_{j}} \}}{{max}_{1 \leq j \leq n} \{ {Delay}_{{mice}_{j}} \} - {min}_{1 \leq j \leq n} \{ {Delay}_{{mice}_{j}} \}} ;$$
$${Loss}_{mice}^{′} = \frac{{Loss}_{{mice}_{i}} - {min}_{1 \leq j \leq n} \{ {Loss}_{{mice}_{j}} \}}{{max}_{1 \leq j \leq n} \{ {Loss}_{{mice}_{j}} \} - {min}_{1 \leq j \leq n} \{ {Loss}_{{mice}_{j}} \}} ;$$
wherein Powerₜₒₜₐₗ_{ᵢ} is a network energy consumption of a current i^{th} flow; Powerₜₒₜₐₗ_{ⱼ} is a network energy consumption set of the j^{th} flow; Powerₜₒₜₐₗ′ is a value of a normalized network energy consumption of a current flow; Lossₑₗₑₚₕₑₙₜ_{ᵢ} is a packet loss rate of a current i^{th} elephant flow; Lossₑₗₑₚₕₑₙₜ_{ⱼ} elephent, is a packet loss rate set of a j^{th} elephant flow; Lossₑₗₑₚₕₑₙₜ′ is a value of a normalized packet loss rate of a current elephant flow; Throughtₑₗₑₚₕₑₙₜ_{ᵢ} is a throughput of the current i^{th} elephant flow; Throughtₑₗₑₚₕₑₙₜ_{ⱼ} is a throughput set of the j^{th} elephant flow; Throughtₑₗₑₚₕₑₙₜ′ is a value of a normalized throughput of the current elephant flow; Delay_{mice}_{ᵢ} is a delay of a current i^{th} mice flow; Delay_{mice}_{ⱼ} is a delay set of j^{th} mice flow; Delay_{mice}′ is a value of a normalized delay of a current mice flow; Loss_{mice}_{ᵢ} is a packet loss rate of the current i^{th} mice flow; Loss_{mice}_{ⱼ} is a packet loss rate set of the j^{th} mice flow; Loss_{mice}′ represents a value of a normalized packet loss rate of the current mice flow.

6. The method for the intelligent traffic scheduling based on the deep reinforcement learning according to claim 1, wherein in the DDPG intelligent routing traffic scheduling framework based on the CNN improvement, a conventional neural network in the DDPG intelligent routing traffic scheduling framework is replaced with the CNN, such that a CNN update process is merged with an online network and a target network in the DDPG intelligent routing traffic scheduling framework.

7. The method for the intelligent traffic scheduling based on the deep reinforcement learning according to claim 2, wherein in the DDPG intelligent routing traffic scheduling framework based on the CNN improvement, a conventional neural network in the DDPG intelligent routing traffic scheduling framework is replaced with the CNN, such that a CNN update process is merged with an online network and a target network in the DDPG intelligent routing traffic scheduling framework.

8. The method for the intelligent traffic scheduling based on the deep reinforcement learning according to claim 5, wherein in the DDPG intelligent routing traffic scheduling framework based on the CNN improvement, a conventional neural network in the DDPG intelligent routing traffic scheduling framework is replaced with the CNN, such that a CNN update process is merged with an online network and a target network in the DDPG intelligent routing traffic scheduling framework.

9. The method for the intelligent traffic scheduling based on the deep reinforcement learning according to claim 6, wherein an update process of the online network and the target network in the DDPG intelligent routing traffic scheduling framework and an interaction process with the environment are as follows:
updating the online network, wherein the online network comprises an Actor online network and a Critic online network, the Actor online network generates a current action αₜ=μ(sₜ|θ^{μ}) as a link weight set, according to a state sₜ and a random initialization parameter θ^{μ} of the link transmission rate, the link utilization rate and the link energy consumption, and interacts with the environment to acquire a reward value rₜ and a next state sₜ₊₁; the state sₜ and the current action αₜ are jointly input into the Critic online network, and the Critic online network iteratively generates a current action value function Q(sₜ,αₜ|θ^{Q}), wherein θ^{Q} is a random initialization parameter; the Critic online network provides gradient information grad[Q] for the Actor online network and helps the Actor online network to update the online network; and
updating the target network, wherein the Actor target network selects a next-time state sₜ₊₁ from an experience replay buffer tuple (sₜ,αₜ,rₜ,sₜ₊₁), and obtains a next optimal action αₜ₊₁=μ′(sₜ₊₁) through iterative training, wherein μ′ represents a deterministic behavior policy function; a network parameter θ^{μ′} is obtained by regularly copying the random initialization parameter θ^{μ} of the Actor online network;
a next action αₜ₊₁ and the next state sₜ₊₁ are jointly input into the Critic target network; the Critic target network performs iterative training to obtain a target value function Q′(sₜ₊₁,μ′(sₜ₊₁|θ^{μ′})|θ^{Q′}); a parameter θ^{Q′} is obtained by regularly copying the random initialization parameter θ^{Q} of the Actor online network.

10. The method for the intelligent traffic scheduling based on the deep reinforcement learning according to claim 9, wherein the Critic online network updates the network parameters with a minimum calculation error through an error equation, and the error equation is
$$L = \frac{1}{N} {{\mathring{a}}_{t} ( {y}_{t} - Q ( {s}_{t} , {a}_{t} \vert {θ}^{Q} ) )}^{2} ,$$
wherein yₜ is a target return value calculated by the Critic target network; L is a mean square error; N is a number of random samples from an experience replay buffer;
the Critic target network provides the target return value yₜ=rₜ+γQ′(sₜ₊₁|θ^{μ′})θ^{Q′}) for the Critic online network, and γ represents a discount factor.

11. The method for the intelligent traffic scheduling based on the deep reinforcement learning according to claim 9, wherein the action set in the step V is Action={α_{w1},α_{w2}, . . . α_{wi}, . . . α_{wz}}, wi∈W;
wherein W is an optional transmission path set of the network traffic; wi represents a wi^{th} path in the optional transmission path set; α_{wi} represents an action value in the action set and refers to a path weight value of the wi^{th} path;
if the network traffic is detected to be the elephant flow, the network traffic is transmitted in a multipath manner, and the elephant flow is distributed according to proportions of different link weights in a total link weight;
if the network traffic is detected to be the mice flow, the network traffic is transmitted in a single-path manner; a path with a maximum link weight is selected as a transmission path for the mice flow through the action set.

12. The method for the intelligent traffic scheduling based on the deep reinforcement learning according to claim 10, wherein the action set in the step V is Action={α_{w1},α_{w2}, . . . α_{wi}, . . . , α_{w2}}, wi∈W;
wherein W is an optional transmission path set of the network traffic; wi represents a wi^{th} path in the optional transmission path set; α_{wi} represents an action value in the action set and refers to a path weight value of the wi^{th} path;
if the network traffic is detected to be the elephant flow, the network traffic is transmitted in a multipath manner, and the elephant flow is distributed according to proportions of different link weights in a total link weight;
if the network traffic is detected to be the mice flow, the network traffic is transmitted in a single-path manner; a path with a maximum link weight is selected as a transmission path for the mice flow through the action set.

13. The method for the intelligent traffic scheduling based on the deep reinforcement learning according to claim 11, wherein an implementation method of the step IV comprises: mapping state elements in the state set into a state feature of the CNN; selecting a link transmission rate S_{LR}_{ₜ}={lr₁(t),lr₂(t), . . . lrₘ(t)} as a state feature input feature₁, a link utilization rate state S_{LUR}_{ₜ}={lur₁(t),lur₂(t), . . . lurₘ(t)} as a state feature input feature₂ and a link energy consumption s_{LP}_{ₜ}={lp₁(t),lp₂(t), . . . lpₘ(t)} as a state feature input feature₃, wherein lr₁(t),lr₂(t), . . . lrₘ(t) respectively represent transmission rates of m links at time t; lur₁(t),lur₂(t), . . . lurₘ(t) respectively represent utilization rates of the m links at the time t; lp₁(t),lp₂(t), . . . lpₘ(t) respectively represent energy consumption of the m links at the time t;
a proportion calculation method comprises: in a traffic transmission from a source node s to a target node d through n paths, calculating a traffic distribution proportion
$${Proportion}_{i} = \frac{{a}_{wi}}{{\sum }_{i = 1}^{n} {a}_{wi}}$$
of each path from the source node s to the target node d.

14. The method for the intelligent traffic scheduling based on the deep reinforcement learning according to claim 5, wherein the reward value function of the elephant flow is:
$${Reward}_{elephent} = η \frac{1}{{Power}_{total}^{′}} + τ \frac{1}{{Loss}_{elephent}^{′}} + ρ {Throught}_{elephent}^{′} ;$$
the reward value function of the mice flow is:
$${Reward}_{mice} = η \frac{1}{{Power}_{total}^{′}} + τ \frac{1}{{Loss}_{mice}^{′}} + ρ \frac{1}{{Delay}_{mice}^{′}} ;$$
wherein the sum of reward value factor parameters η, τ and ρ is 1; Powerₜₒₜₐₗ′ is a normalization result of the total network energy consumption Powerₜₒₜₐₗ in the network traffic transmission process; Lossₑₗₑₚₕₑₙₜ′ is a normalization result of the average packet loss rate Lossₑₗₑₚₕₑₙₜ of the elephant flow; Throughtₑₗₑₚₕₑₙₜ′ is a normalization result of the average throughput Throughtₑₗₑₚₕₑₙₜ of the elephant flow; Loss_{mice}′ is an average packet loss rate Loss_{mice} of the mice flow; Delay_{mice}′ is a normalization result of the average end-to-end delay Delay_{mice} of the mice flow.

15. The method for the intelligent traffic scheduling based on the deep reinforcement learning according to claim 6, wherein the reward value function of the elephant flow is:
$${Reward}_{elephent} = η \frac{1}{{Power}_{total}^{′}} + τ \frac{1}{{Loss}_{elephent}^{′}} + ρ {Throught}_{elephent}^{′} ;$$
the reward value function of the mice flow is:
$${Reward}_{mice} = η \frac{1}{{Power}_{total}^{′}} + τ \frac{1}{{Loss}_{mice}^{′}} + ρ \frac{1}{{Delay}_{mice}^{′}} ;$$
wherein the sum of reward value factor parameters η, τ and ρ is 1; Powerₜₒₜₐₗ′ is a normalization result of the total network energy consumption Powerₜₒₜₐₗ in the network traffic transmission process; Lossₑₗₑₚₕₑₙₜ′ is a normalization result of the average packet loss rate Lossₑₗₑₚₕₑₙₜ of the elephant flow; Throughtₑₗₑₚₕₑₙₜ′ is a normalization result of the average throughput Throughtₑₗₑₚₕₑₙₜ of the elephant flow; Loss_{mice}′ is an average packet loss rate Loss_{mice} of the mice flow; Delay_{mice}′ is a normalization result of the average end-to-end delay Delay_{mice} of the mice flow.

16. The method for the intelligent traffic scheduling based on the deep reinforcement learning according to claim 9, wherein the reward value function of the elephant flow is:
$${Reward}_{elephent} = η \frac{1}{{Power}_{total}^{′}} + τ \frac{1}{{Loss}_{elephent}^{′}} + {ρThrought}_{elephent}^{′} ;$$
the reward value function of the mice flow is:
$${Reward}_{mice} = η \frac{1}{{Power}_{total}^{′}} + τ \frac{1}{{Loss}_{mice}^{′}} + ρ \frac{1}{{Delay}_{mice}^{′}} ;$$
wherein the sum of reward value factor parameters η, τ and ρ is 1; Powerₜₒₜₐₗ′ is a normalization result of the total network energy consumption Powerₜₒₜₐₗ in the network traffic transmission process; Lossₑₗₑₚₕₑₙₜ′ is a normalization result of the average packet loss rate Lossₑₗₑₚₕₑₙₜ of the elephant flow; Throughtₑₗₑₚₕₑₙₜ′ is a normalization result of the average throughput Throughtₑₗₑₚₕₑₙₜ of the elephant flow; Loss_{mice}′ is an average packet loss rate Loss_{mice} of the mice flow; Delay_{mice}′ is a normalization result of the average end-to-end delay Delay_{mice} of the mice flow.

17. The method for the intelligent traffic scheduling based on the deep reinforcement learning according to claim 11, wherein the reward value function of the elephant flow is:
$${Reward}_{elephent} = η \frac{1}{{Power}_{total}^{′}} + τ \frac{1}{{Loss}_{elephent}^{′}} + {ρThrought}_{elephent}^{′} ;$$
the reward value function of the mice flow is:
$${Reward}_{mice} = η \frac{1}{{Power}_{total}^{′}} + τ \frac{1}{{Loss}_{mice}^{′}} + ρ \frac{1}{{Delay}_{mice}^{′}} ;$$
wherein the sum of reward value factor parameters η, τ and ρ is 1; Power ₜₒₜₐₗ′ is a normalization result of the total network energy consumption Powerₜₒₜₐₗ in the network traffic transmission process; Lossₑₗₑₚₕₑₙₜ′ is a normalization result of the average packet loss rate Lossₑₗₑₚₕₑₙₜ of the elephant flow; Throughtₑₗₑₚₕₑₙₜ′ is a normalization result of the average throughput Throughtₑₗₑₚₕₑₙₜ of the elephant flow; Loss_{mice}′ is an average packet loss rate Loss_{mice} of the mice flow; Delay_{mice}′ is a normalization result of the average end-to-end delay Delay_{mice} nice of the mice flow.
